(19) United States
(12) Patent Application Publication
(10) Pub. No.: US 2025/0061523 A1
(43) Pub. Date: Feb. 20, 2025

(54) A COMPUTER-IMPLEMENTED METHOD FOR GENERATING A SOIL PROPERTY MAP OF AN AGRICULTURAL FIELD

(71) Applicant: BASF AGRO TRADEMARKS GMBH, Ludwigshafen (DE)

(72) Inventors: Christian VON HEBEL, Koeln (DE); Mollie Jo HOSS-KUHNE, Windeck (DE); Bjoern KIEPE, Koln (DE)

(21) Appl. No.: 18/721,585

(22) PCT Filed: Dec. 19, 2022
(86) PCT No.: PCT/EP2022/086598

§ 371 Date: Jun. 18, 2024

(30) Foreign Application Priority Data
Dec. 21, 2021 (EP) 21216256.4

(51) Int. Cl. G06Q 50/02; A01B 79/00

(52) U.S. Cl. CPC G06Q 50/02; A01B 79/005

(57) ABSTRACT

A computer-implemented method for generating a soil property map of an agricultural field, comprising the steps: receiving crop property distribution data of the agricultural field comprising at least one crop related parameter (S1); determining equivalent areas having a crop related parameter value within a certain range in the crop property distribution data (S2); receiving soil data with respect to at least one soil parameter for each of the determined equivalent areas (S3); generating a soil property map of the agricultural field based on the soil data and the equivalent areas (S4).

### TECHNICAL FIELD

The present disclosure relates to a computer-implemented method for generating a soil property map of an agricultural field, a system for generating a soil property map of an agricultural field and a computer program element. Furthermore, the present disclosure is directed to a use of crop property distribution data of the agricultural field or of biomass distribution data and/or soil data, and to a use of a soil property map.

### TECHNICAL BACKGROUND

The general background of this disclosure is the treatment of plants in an agricultural field, which may be an agricultural field, a greenhouse, or the like. The treatment of plants, such as the cultivated crops, may also comprise the treatment of weeds present in the agricultural field, the treatment of the insects, present in the agricultural field or the treatment of pathogens present in the agricultural field.

It has been found that a need exists to provide information to control a treatment device for treating an agricultural field.

An important type of such information relates to soil property of the agricultural field. The control of the treatment device can then consider the soil property thereby rendering the treatment more ecological and/or economical.

To make farming more sustainable and reduce environmental impact precision farming technology is being developed. Here a semi-automated or fully automated plant treatment device, such as a drone, a robot, a smart sprayer, or the like, may be configured to treat plants, weeds, insects and/or pathogens in the agricultural field based on ecological and economical rules. The technological developments in the field of drones or in robotics enable new treatment schemes for farmers.

The disclosed methods enable high precision and zone-specific agricultural management, soil management and sustainability of soil treatment in particular for recommendation on seeding density and/or crop nutrition by combining remotely measured crop and ground-based soil information.

### SUMMARY OF THE INVENTION

In one aspect of the present disclosure a computer-implemented method for generating a soil property map of an agricultural field is presented, the method comprising the steps:
receiving crop property distribution data of the agricultural field comprising at least one crop related parameter;
determining equivalent areas having a crop related parameter value within a certain range in the crop property distribution data;
receiving soil data with respect to at least one soil parameter for each of the determined equivalent areas;
generating a soil property map of the agricultural field based on the soil data and the equivalent areas.

In a further aspect of the present disclosure, a system for generating a soil property map of an agricultural field is presented, the system comprising:
a first receiving unit configured to receive crop property distribution data of the agricultural field comprising at least one crop related parameter;
a determining unit configured to determine equivalent areas having a crop related parameter value within a certain range in the crop property distribution data;
a second receiving unit configured to receive soil data with respect to at least one soil parameter for each of the determined equivalent areas;
a generating unit configured to generate a soil property map of the agricultural field based on the soil data and the equivalent areas.

In another aspect of the present disclosure, a computer program element is presented, comprising instructions, which, when executed on computing devices of a computing environment, is configured to carry out the steps of the method according to the present disclosure in a system according to the present disclosure.

In an additional aspect of the present disclosure, a use of crop property distribution data of the agricultural field or of biomass distribution data and/or soil data in a method according to the present disclosure is presented.

In a further aspect of the present disclosure, a use of a soil property map is presented, the soil property map being provided according to a method according to the present disclosure for providing treatment instruction data for an agricultural equipment for treating the agricultural field.

Any disclosure and embodiments described herein relate to the method, the system, the computer program element and the uses lined out above and vice versa. Advantageously, the benefits provided by any of the embodiments and examples equally apply to all other embodiments and examples and vice versa.

As used herein “determining” also includes “initiating or causing to determine ”, “generating” also includes “initiating or causing to generate” and “providing” also includes “initiating or causing to determine, generate, select, send or receive”. “Initiating or causing to perform an action” includes any processing signal that triggers a computing device to perform the respective action.

The method, system, computer program element and uses disclosed herein provide an efficient, sustainable and robust way for treating an agricultural field. In particular, a soil property map of an agricultural field can be provided at reduced costs while maintaining a high accuracy or even improving accuracy allowing an improved soil management which in turn can improve the sustainability of soil treatment.

The general idea underlying the present disclosure is to use crop property distribution data to determine equivalent areas, wherein the crop property distribution data comprises at least one crop related parameter. This means that areas of the agricultural field having the same or a similar crop related parameter are considered to be equivalent. In this context, crop related parameters may be considered similar if they differ by less than a predefined absolute or relative amount. Moreover, a second crop related parameter may be considered similar to a first crop related parameter if it falls within a predefined range around the first crop related parameter. Notably, a crop related parameter may be considered to be equivalent, for example, if the crop related parameter is within a certain/predefined range, e.g. plus or minus 50%, more preferably plus or minus 40%, most preferably plus or minus 30%, particularly preferably plus or minus 20%, particularly plus or minus 10% of the corresponding crop related parameter value of a crop related parameter. Moreover, crop related parameters may be considered similar if they differ by less than 50%, preferably less than 40%, more preferably less than 30%, particularly preferably less than 20% and particularly less than 10%. This leads to the fact that it is possible to generate an accurate soil property map by using soil data relating to the equivalent areas only.

Consequently, the amount of soil data necessary for generating the soil map can be drastically reduced as compared to known approaches, wherein an agricultural field is subdivided into a number of zones and soil data has to be received for each of these zones. As a consequence, thereof, the effort for generating this soil data can be reduced.

In an illustrative example, a known method for providing a soil property map consists in subdividing the agricultural field in ten zones and taking a soil sample from each of these zones. Then, based on soil data derived from the soil samples, the soil property map is generated. Using the method of the present disclosure, on the same agricultural field only three equivalent areas may be determined. Thus, here, only three soil samples are necessary, i.e. one for each equivalent area. Therefore, in the present example, soil samples at and around three locations are necessary, which best represent the equivalent area. The soil property map can thus be generated with reduced effort.

It is an object of the present invention to provide an efficient, sustainable and robust way of treating an agricultural field. These and other objects, which become apparent upon reading the following description, are solved by the subject matter of the independent claims. The dependent claims refer to preferred embodiments of the invention.

### DEFINITIONS

The term treatment device is to be understood broadly in the present case and comprises any device configured to treat an agricultural field. The treatment device may be configured to traverse the agricultural field. The treatment device may be a ground or an air vehicle, e.g. a rail vehicle, a robot, an aircraft, an unmanned aerial vehicle (UAV), a drone, or the like. The treatment device may by equipped with one or more treatment unit(s) and/or one or more monitoring unit(s). The treatment device may be configured to collect field data via the treatment and/or monitoring unit. The treatment device may be configured to sense field data of the agricultural field via the monitoring unit. The treatment device may be configured to treat the agricultural field via the treatment unit. Treatment unit(s) may be operated based on monitoring signals provided by the monitoring unit(s) of the treatment device. The treatment device may comprise a communication unit for connectivity. Via the communication unit the treatment device may be configured to provide or send field data, to provide or receive operation data and/or to provide or receive operation data.

Treatment operation as used herein refers to data characterizing an operation of the treatment device for treating the agricultural field, particularly a field condition of the agricultural field. A treatment operation identifier may indicate treatment operation. Treatment operation may be characterized by a treatment type and/or a treatment mode. Treatment type may refer to an application type, such as seeding, harvesting, chemical application and the like, wherein seeding is the preferred treatment type. Treatment mode refers to a mode or a class of modes or treatment indications for a single treatment type. For chemical application treatment such as spraying, modes may be herbicide A application, fungicide A application, insecticide A application, flat spray, spot spray or the like. Treatment operation may include any data for characterization, activation or operation of the treatment device for treating the agricultural field.

Monitoring operation as used herein refers to an operation of the treatment device for monitoring the agricultural field, particularly collecting field data of the agricultural field. A monitoring operation identifier may indicate monitoring operation. Monitoring operation may be characterized by a monitoring type and/or a monitoring mode. Monitoring type refers to a monitoring indication, such as plant sensing for weed treatment, soil sensing for seeding, and the like. Monitoring mode refers to the mode or a class of modes for a single monitoring type. For plant sensing, modes may be weed image detection, crop image detection, fungi optical detection or the like. Monitoring operation may include any data for characterization, activation or operation of the treatment device for monitoring the agricultural field.

The term treatment as used herein may relate to any treatment for the cultivation of plants. The term treating or treatment is to be understood broadly in the present case and relates to any treatments of the agricultural field such as seeding, applying products, harvesting etc.

The term treatment product is understood to be any object or material useful for the treatment. In the context of the present invention, the term treatment product includes but is not limited to:
chemical products such as fungicide, herbicide, insecticide, acaricide, molluscicide, nematicide, avicide, piscicide, rodenticide, repellant, bactericide, biocide, safener, plant growth regulator, urease inhibitor, nitrification inhibitor, denitrification inhibitor, or any combination thereof.
biological products such as microorganisms useful as fungicide (biofungicide), herbicide (bioherbicide), insecticide (bioinsecticide), acaricide (bioacaricide), molluscicide (biomolluscicide), nematicide (bionematicide), avicide, piscicide, rodenticide, repellant, bactericide, biocide, safener, plant growth regulator, urease inhibitor, nitrification inhibitor, denitrification inhibitor, or any combination thereof.
fertilizer and nutrient,
seed and seedling,
water, and
any combination thereof, wherein within the present disclosure, the treatment product is preferably a fertilizer product, a nutrient product and/or a seed or seedling.

Distributed computing environment as used herein refers to a distributed machinery setup with multiple treatment devices for treating the agricultural field. The multiple treatment devices may be interconnected. The multiple treatment devices may be connected via distributed computing devices. The computing devices may be part of the treatment devices and/or remote from the treatment devices connected through a network.

Agricultural field as used herein refers to an agricultural field to be treated. The agricultural field may be any plant or crop cultivation area, such as a farming field, a greenhouse, or the like. A plant may be a crop, a weed, a volunteer plant, a crop from a previous growing season, a beneficial plant or any other plant present on the agricultural field. The agricultural field may be identified through its geographical location or geo-referenced location data. A reference coordinate, a size and/or a shape may be used to further specify the agricultural field.

Field data as used herein is to be understood broadly in the present case and comprises any data that may be obtained by the treatment device. Field data may be obtained from the treatment unit and/or the monitoring unit of the treatment device. Field data may comprise measuring data obtained by the treatment device. Measuring data may comprise data related to a field condition on the agricultural field and/or to an operation of the treatment device. Field data may comprise image data, spectral data, section data indicating flagged sections derived plant data, derived crop data, derived weed data, derived soil data, geographical data, trajectory data of the treatment device, measured environmental data (e.g. humidity, airflow, temperature, and sun radiation), and treatment data relating to the treatment operation. The field data may be associated with a section such as location or position data of the section.

Field condition as used herein may relate to a condition sensed on the agricultural field including treatment or monitoring on the agricultural field. The field condition may be derived from measuring data. The field data may comprise the field condition. The field condition may signify the presence of a certain treatment requirement such as the presence of certain weeds, insects or fungi in sections of the agricultural field. The field condition may be related to a status flag of the section of the agricultural field. A status flag may be “to be treated”, “untreated” or “treated”. The status flag “to be treated” may relate to the detection of a field condition that signifies treatment is required. E.g. a weed, a fungus, a nutrient level, a water level, a growth stage or any another condition may be detected on the field e.g. by the monitoring unit of the treatment device that requires treatment. The status flag “treated” may relate to the treatment status of the field that signifies treatment was conducted. The status flag “untreated” may relate to the detection of a field condition that signifies no treatment is required.

Section of the agricultural field is to be understood broadly in the present case and relates to at least one position or location on the agricultural field. The section may relate to a zone of the agricultural field including multiple positions or locations on the agricultural field forming a contiguous area of the agricultural field. The section may relate to distributed patches of the agricultural field multiple positions or locations on the agricultural field indicating a common field condition. The section may be flagged indicating the field condition of the section. The section may include one or more position(s) or location(s) on the agricultural field flagged with one or more flags indicating the field condition. The agricultural field may comprise one or more sections. The sections may be related to field data, in particular field conditions. The section may be flagged. The section may be identified through its geographical location or geo-referenced location data. A reference coordinate, a size and/or a shape may be used to further specify the section.

Operation data as used herein is to be understood broadly in the present case and relates to any data configured to operate the treatment device. The term operation data refers to data configured for operating at least one treatment device in relation to other treatment devices. The operation data may be configured to control one more technical means of the treatment device. The operation data may comprise data to control a treatment and/or monitoring unit of the treatment device. The operation data may be configured to control movement of the treatment device. The operation data may be configured to control a steering and drive unit of the treatment device. The operation data may be configured to control one treatment device in relation to other treatment devices.

In an embodiment, the method further comprises the step of generating treatment instruction data for an agricultural equipment based on the soil property map. The treatment by the agricultural equipment can thus be performed in function of the soil data being provided in the soil property map. This means that different equivalent areas may be treated in a different manner. This enhances crop quality and crop yield while at the same time being efficient both in economic terms and ecological terms. This is due to the fact that by applying the method, the appropriate treatment using the appropriate agricultural equipment and appropriate treatment product in the appropriate quantity can be used.

In another embodiment, the crop property distribution data is biomass distribution data and the crop related parameter value is a biomass value. Such crop property distribution data can be generated in a simple and cost-efficient manner, e.g. based on images taken by satellites or unmanned aerial vehicles. This renders the method of the present disclosure also simple and cost-efficient. At the same the biomass distribution data and the biomass value is a reliable and accurate parameter for determining equivalent areas. This leads to reliable and precise soil property maps. Furthermore, biomass values and corresponding biomass distribution data can be analyzed in a computationally efficient manner.

According to a further embodiment, the biomass distribution data is derived from a yield distribution data of the agricultural field. The yield distribution data is comparatively easy to generate, e.g. by a treatment device. Moreover, the yield distribution data is a reliable and sufficiently precise indicator of the biomass distribution data. Thus, the biomass distribution data can be generated in a simple and reliable manner.

In another embodiment, the biomass distribution data is derived from satellite image data of the agricultural field. Such images are available at comparatively low cost and high accuracy from satellite operation organizations. Thus, the sourcing of satellite images is simple and cost-efficient. These images can be analyzed in order to derive the biomass distribution. To this end, standard image analysis techniques can be used, which are sufficiently fast, reliable and accurate. In summary, the biomass distribution data can be provided in a fast, simple and reliable manner.

In a further embodiment, the biomass distribution data is derived from plant data of the agricultural field. The plants form part of the biomass, especially, the plants form the vast majority of the biomass on the agricultural field. Thus, accurate and reliable biomass distribution data can be generated by aggregating plant data. This is simple and reliable.

In another embodiment, the biomass distribution data is received from a data base, a current measurement or a user input. Of course, these alternatives can also be combined. They all are reliable sources for biomass distribution data which can be accessed in a simple manner.

In an embodiment, the biomass distribution data is derived from historical biomass distribution data. The historical biomass distribution data are from not less than 2 years, more preferably not less than 4 year, even more preferably not less than 8 years, most preferably not less than 10 years. An advantage thereof is that for the generation of current biomass distribution data, no actual analysis of the agricultural field, e.g. by measurement or by taking images, is necessary. The bigger the base of historic biomass distribution data, the more accurate is the derived biomass distribution data. This leads to the efficient generation of a reliable and accurate soil property map.

In another embodiment, the method comprises the step of providing soil sampling location data in the agricultural field based on the determined equivalent areas. Preferably, soil sampling route data for a soil sampling device through the agricultural field is provided and/or a soil sampling map data for the agricultural field is provided. The soil sampling location data, the soil sampling route data and the soil sampling map data can be summarized as operational data or operational instructions for a soil sampling device. In simplified words, using this operational data consists in instructing the soil sampling device. Providing this data thus offers a basis for efficiently operating the soil sampling device, i.e. for efficiently taking soil samples and subsequently providing soil data. It is again noted that the sampling is to be based on the equivalent areas and therefore less samples need to be taken as compared to sampling in a regular geometrical pattern. For example, the soil sampling location data can comprise one sampling location information for each of the equivalent areas. The soil sampling route data may then describe the shortest and fastest route for connecting the sampling locations.

In a further embodiment, the sampling location data comprises between one and ten, preferably between two and seven, more preferably between four and six and most preferably only one soil sampling location(s) for each equivalent area. This has proven to be a good compromise between the effort made for taking soil samples and providing the corresponding soil data on the one hand and the accuracy and reliability of the soil property map on the other hand.

In another embodiment, the method further comprises the step of providing soil sampling timing data with respect to the time the soil samples have to be obtained. Consequently, dynamic processes within the soil, potentially running on different time scales, can be respected when obtaining the samples. For example, a sample having been obtained in order to assess soil properties being connected to the use of a fertilizer, e.g. a phosphate fertilizer or any other fertilizer applicable, may be valid for three to five years. Thus, soil sampling timing data may respect the timing data of a previous sample. The same applies to samples having been obtained in order to assess properties being connected to a pH value or the liming of the agricultural field. Also such samples may be valid for three to five years. In contrast thereto, a sample having been obtained in order to assess soil properties being connected to nitrogen, for example, may be generally valid for a short period of time and need to be measured more frequently, e.g. one year or less. Thus, the sampling timing data can be adapted respectively. The use of the sampling timing data is helpful for receiving reliable and accurate soil data and therefore leads to the generation of reliable and accurate soil property maps.

The method according to any one of the preceding claims, further comprising the step of providing soil sampling method data. Using soil sampling method data, a specific soil sampling method can be suggested. Also, a list of suitable soil sampling methods can be provided, e.g. a proximal soul sampling/sensing method (e.g. ground-penetrating radar, electromagnetic induction, electrical resistivity, magnetometry, magnetic susceptibility, X-Ray fluorescence, mechanical interactions, ion-selective potentiometry, seismic, gamma ray, etc.). This makes sure that accurate and relevant soil data is received. Consequently, a soil property map of high quality can be generated.

The method according to any one of the preceding claims, wherein the soil data is or relates to: soil organic matter, total carbon content, organic carbon content, inorganic carbon content, soil humus content, boron content, phosphorus content, potassium content, nitrogen content, sulfur content, calcium content, iron content, aluminum content, chlorine content, molybdenum content, magnesium content, nickel content, copper content, zinc content, Manganese content, pH value of the soil in the field or the sub-field zone, soil quality, soil sandiness, soil moisture, soil humidity, soil temperature, soil surface temperature, soil density, soil texture, soil conductivity, water holding capacity, clay content, silt content, and/or sand content of the soil. These soil parameters have an influence on the crop quality of crops being cultivated on the agricultural field.

In the present disclosure, crop quality may relate to at least one of: protein content, sugar content, starch content, oil content, gluten content, vitamin content, pro-vitamin content, fatty acids content, unsaturated fatty acids content, omega-n fatty acids content, omega-3 fatty acids content, dietary fiber content, minerals content, antioxidants content, phytohormone content, and other substances with nutritional value for humans or animals fed with the corresponding crops.

In a further embodiment, the method further comprises the step of providing control data for controlling an agricultural equipment based on the soil property map and/or the treatment instruction data. The generated soil property map can be used with seed data or nutrition data or crop protection data or weed management data to generate a prescription map for zone-based seeding or zone-based fertilization or zone-based fungicide, insecticide, and pesticide or zone-based herbicide application. For sustainable use and dosage all of the beforementioned treatments require zone-specific characterization of soil properties.

In another embodiment, the system according to the present disclosure comprises a further generating unit configured to generate treatment instruction data for an agricultural equipment based on the soil property map. Thus, the soil property map is directly used for treatments or treatment operations. The generation of the treatment instruction data and the provision of the treatment instruction data to the agricultural equipment is preferably done automatically. Consequently, an appropriate treatment can be determined quickly and in a high reliable manner. This also leads to enhanced crop quality.

In a further embodiment, the system further comprises a providing unit for providing control data for controlling an agricultural equipment based on the soil property map and/or the treatment instruction data. A zone-specific prescription map generated by the soil property map paired with treatment data, can be transferred e.g., via pen-drive, wifi, or other data transferring method to the agricultural monitor in the tractor that steers the agricultural implement such as the planter for the seeding treatment or the fertilizer spreader for the nutrition treatment or the sprayer for the crop protection and for the weed management.

The method disclosed herein may further comprise the step of forwarding the field data and/or the operation data to a remote computing device for storing the field data and/or the operation data for further data processing. Owing to the limited storage capacity of treatment devices and the utilization of big data to enhance, remote storage capacity is beneficial. To reduce impact of such forwarding on processing capacities, forwarding may be done through batch data processing.

### BRIEF DESCRIPTION OF THE DRAWINGS

In the following, the present disclosure is further described with reference to the enclosed figures:

FIG. 1 illustrates an example embodiment of a system with multiple UAVs for treatment of an agricultural field;

FIG. 2 is a schematic illustration of a UAV adapted for treating the agricultural field;

FIG. 3 is a schematic illustration of a ground robot adapted for treating the agricultural field;

FIG. 4 illustrates an example of a system for generating a soil property map of an agricultural field;

FIG. 5 illustrates equivalent areas of an agricultural field and a soil property map being generated by the system of FIG. 4;

FIG. 6 illustrates a flow diagram of an example method for generating a soil property map of an agricultural field; and

FIG. 7 illustrates a soil property map according to a different example being generated by the system of FIG. 4.

### DETAILED DESCRIPTION OF EMBODIMENT

The disclosure is based on the finding that agricultural fields comprise heterogeneous characteristics (e.g. soil, plant, weed, etc.) distributed over the entire agricultural field. These characteristics are not permanent and therefore not completely known before the treatment devices treat the agricultural field. By monitoring, e.g. with means of a treatment device during a treatment process of an agricultural, these specific characteristics of the agricultural field are at least partly revealed. This advantageous information about these specific characteristics serves to beneficially improve the treatment strategy of one or more further treatment devices. By doing so, it is possible to react on changing conditions in the agricultural field on demand. In other words, the method collects field data e.g. via means of a treatment devices passing through the agricultural field and provides operation data based on the field data to the same or a further treatment device. This enables a demand driven treatment of an agricultural field. This advantageously increases the treatment efficiency.

The following embodiments are mere examples for implementing the method, the system, the computer element, or the uses disclosed herein and shall not be considered limiting.

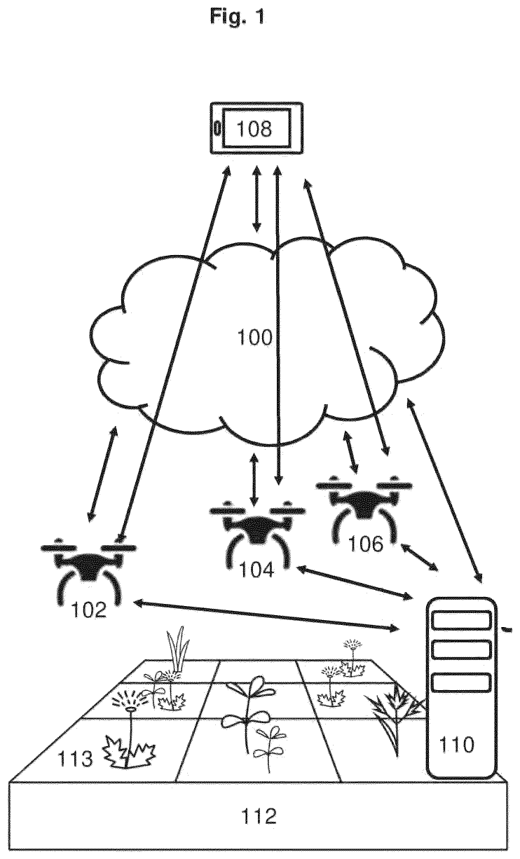

FIG. 1 illustrates an exemplarily embodiment of a system with multiple UAVs as treatment devices.

The system of FIG. 1 shows a distributed system including multiple UAVs 102, 104, 106, one or more ground station(s) 110, one or more user device(s) 108, and a cloud environment 100. The UAV 102, 104, 106 is an unmanned aerial vehicle which can be controlled autonomously by onboard computers, remotely by a pilot controller or partially remotely e.g. by way of initial operation data. UAVs 102, 104, 106 may transmit data signals collected from various onboard sensors and actors mounted to the UAV. Such data may include current flight data such as current altitude, speed, battery level, position, weather or wind speed, field data including treatment operation data such as treatment type, treatment location or treatment mode, monitoring operation data such as field condition data or location data, and/or operation data, such as initial operation data, updated operation data or current operation data. The UAVs 102, 104, 106 may directly or indirectly send data signals, such as field data or operation data, to the cloud environment 100, the ground station(s) 110 or other UAVs 102, 104, 106. The UAVs 102, 104, 106 may directly or indirectly receive data signals, such as field data or operation data, from cloud environment 100, the ground station(s) 110 or other UAVs 102, 104, 106.

More generally speaking, each of the UAVs 102, 104, 106 can be designated an agricultural equipment.

The cloud environment 100 may facilitate data exchange with and between the UAVs 102, 104, 106, the ground control station(s) 110, and user device(s) 108. The cloud environment 100 may be a server-based distributed computing environment for storing and computing data on multiple cloud servers accessible over the Internet. The cloud environment 100 may be a distributed ledger network that facilitates a distributed immutable database for transactions performed by UAVs 102, 104, 106, one or more ground station(s) 110 or one or more user device(s) 108. Ledger network refers to any data communication network comprising at least two network nodes. The network nodes may be configured to a) request the inclusion of data by way of a data block and/or b) verify the requested inclusion of data to the chain and/or c) receiving chain data. In such a distributed architecture, the UAVs 102, 104, 106, one or more ground station(s) 110, one or more user device(s) 108 can act as nodes storing transaction data in data blocks and participating in a consensus protocol to verify transactions. If the at least two network nodes are in a chain the ledger network may be referred to as a block chain network. The ledger network 100 may be composed of a block chain or cryptographically linked list of data blocks created by the nodes. Each data block may contain one or more transactions relating to field data or operation data. Block chain refers to a continuously extendable set of data provided in a plurality of interconnected data blocks, wherein each data block may comprise a plurality of transaction data. The transaction data may be signed by the owner of the transaction and the interconnection may be provided by chaining using cryptographic means. Chaining is any mechanism to interconnect two data blocks with each other. For example, at least two blocks may be directly interconnected with each other in the block chain. A hash-function encryption mechanism may be used to chain data blocks in a block chain and/or to attach a new data block in an existing block chain. A block may be identified by its cryptographic hash referencing the hash of the preceding block.

The UAVs 102, 104, 106 and the ground station(s) 110 may share data signals with the user device(s) 108 via the cloud environment 100. Communication channels between the nodes and communication channels, between the nodes and the cloud environment 100 may be established through a wireless communication protocol. A cellular network may be established for UAV 102, 104, 106 to UAV 102, 104, 106, UAV 102, 104, 106 to ground station 110, UAV 102, 104, 106 to cloud environment 100 or ground station 110 to cloud environment 100 communication. Such cellular network may be based any known network technology such as SM, GPRS, EDGE, UMTS/HSPA, LTE technologies using standards like 2G, 3G, 4G or 5G. In a local area of an agricultural field 112 a wireless local area network (WLAN), e.g. Wireless Fidelity (Wi-Fi), may be established for UAV 102, 104, 106 to UAV 102, 104, 106 or UAV 102, 104, 106 to ground station 110 communication. The cellular network for UAV 102, 104, 106 to UAV 102, 104, 106 or UAV 102, 104, 106 to ground station 110 may be a Flying Ad Hoc Network (FANET).

The first UAV 102 may be configured to perform a first treatment operation and the second UAV 104 may be configured to perform a second treatment operation. Preferably UAV 102, 104, 106 treatment operation may differ with respect to the treatment type or the treatment mode. The term treatment type relates to the used application principle. The application type may comprise seeding, harvesting, chemical application or the like. The treatment mode for chemical application may be a spray mode (e.g. flat, spot, variable rates), for mechanical applications may be a removal mode (e.g. grabber, cutter), for electrical applications may be electrical application mode (e.g. laser, voltage pulse). The term treatment type relates to a weed class and corresponding herbicide classes, fungicide classes, pesticide classes. Further, the term treatment type relates to a plant and corresponding fertilizer classes.

In an example implementation the first UAV 102 carries a treatment product different to the second UAV 106. E.g. the first UAV 102 is a scout and spray UAV configured to sense field conditions and to apply a first treatment product. E.g. the second UAV 104 is a sprayer drone applying a second treatment product. The first UAV 102 collects along its trajectory field data. E.g. a weed, fungi or insect distribution or a weed, fungi or insect type to be treated with the second treatment product is collected along the scout and spray drone's trajectory and associated with location data. Based on the field data operation data for the second UAV 104 is determined. E.g. based on the sensed weed, fungi or insect distribution and the sensed weed, fungi or insect type, locations to be treated with the second treatment product are identified and operation data for the second UAV 104 carrying the second treatment product is determined. The operation data is provided to the second UAV 104. The operation data may be initial or adapted operation data of the second UAV. E.g. the trajectory may be adapted according the location of the weed, fungi or insect to be treated. In other words, if the first UAV 102 determines that it does not have a required treatment product or does not carry technical equipment needed for treatment, the second UAV 104 can be called to a section 113, the second UAV 104 carrying the needed product or technical equipment. For example if the first UAV 102 determines a weed, fungi or insect in the section 113 of the agricultural field 112 and that it does not carry a necessary herbicide, fungicide or insecticide, the above described method provides the information and/or derived instructions to the second UAV 104 or a further UAV 106 carrying the necessary herbicide, fungicide or insecticide such that the second and/or the further UAV 104, 106 can kill the weed, fungi or insect in the section 113.

In another example, the first UAV 102 may just not have enough treatment product and cannot treat the entire sections 113 in the field 112. In this example, the method would provide the second and/or the further UAV 104, 106 the information of the section 113 not treated yet by the first UAV 102 in order to treat the section 113. In another example, the first UAV 102 may for example just monitor the sections 113 in the field 112 in order to provide field data, wherein the method then provides operation data based the field data to the second and/or further treatment devices 102, 106. In this example the first UAV 102 serves as a scout drone.

In these examples, the operation data determination may be implemented locally on a computing device of the first UAV 102, the second UAV 104 or the ground station 110. The operation data determination may also be implemented using the distributed cloud environment 100. The field data and/or operation data may be provided through real time and/or batch data processing. To reduce latency and save bandwidth a smart data transfer management is beneficial. Field data may be batch processed for treated sections 113 and real-time processed for untreated sections 113. Operation data may be batch processed for treated sections and real-time processed for untreated sections 113. Operation data for untreated sections 113 may be provided in real-time to treatment devices. Field data for untreated sections 113 may be provided in real-time to operation data determination units. Real time as used herein refers to data transfer not being actively stalled or queued. Data transfer is viewed real time, if the transfer delay is due to processing or transfer capacity of the processing system(s) involved.

The operation data in these examples specifies if the UAVs 104 work in a sequential or simultaneous mode. In a sequential mode the first UAV 104 crosses the field 112 or sections 113 of the field 112 before the second UAV 104 or the other UAVs 106 initiate the treatment of the field 112. In a simultaneous mode the first, the second and other UAVs UAV 102, 104, 106 act simultaneously on the field 112. A simultaneous mode may be realized via a swarm algorithm, a fuzzy logic algorithm or any other algorithm that operates self-organized collective systems.

It should be noted at this point, that the description applies to any number of treatment devices with different hardware properties. For example, instead of one first UAV 102 a group of first UAVs 102 may sense field conditions and treat the field 112 according their operation data, wherein the first UAVs 102 are equivalent. The same may apply to the second UAV 104, where a group of second UAVs 104 may sense field conditions and treat the field 112 according their operation data, wherein the first UAVs 102 are equivalent. Additionally the number of UAVs 102, 104, 106 active in the field 112 may be adjusted according to the demand derived from the field data. The operation data may then include instruction data or a logic to orchestrate operation of more than one UAV 102, 104, 106 on the field 112. E.g., the group of first UAVs 102 may be operated in swarm mode and a group of second UAVs may be operated in swarm mode, wherein the group of second UAVs 104 may be operated in a sequential mode with respect to the group of first UAVs 102.

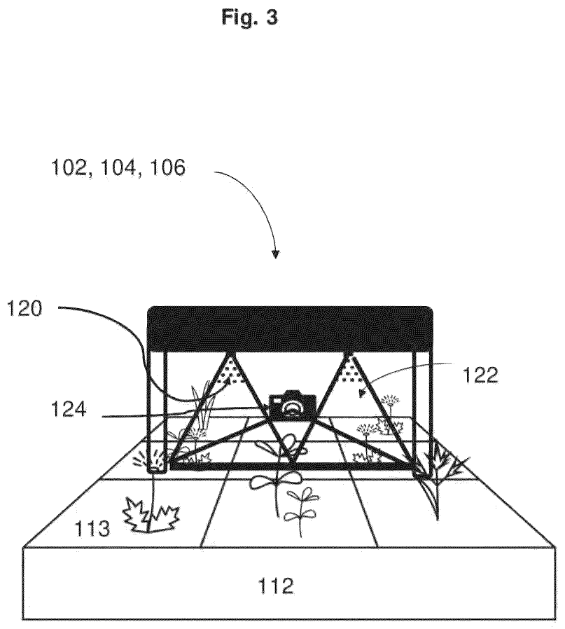

The treatment devices on the field 112 may comprise further ground or other flying vehicles (not shown). The treatment devices may comprise a robot (FIG. 3), a tractor, a harvester, a seeder, a sprayer or any other agricultural vehicle. The treatment devices may be configured to monitor an agricultural field. The treatment device may be configured to apply any treatment product (e.g. water, herbicide, fungicide, fertilizer, seeds). The treatment device may be configured to prepare the field 112 for seeding. The treatment device may be configured to harvest a plant in a field 112. Within the present disclosure the treatment device is preferably a seeder and the treatment product is preferably a seed.

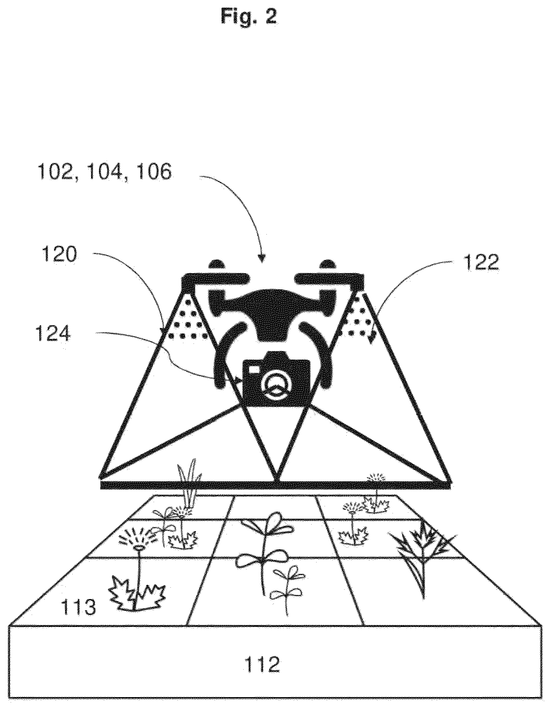

FIG. 2 illustrates the flying UAV 102, 104, 106 adapted for treating the agricultural field 112.

The UAV 102, 104, 106 shown in this example includes a camera as monitoring unit 124 for monitoring field condition(s) and two spray nozzles as treatment units 120, 122 for spraying treatment product. The spray nozzles 120, 122 are in fluid connection to at least one tank carried by the UAV 102, 104, 106. Such set up allows for more efficient and targeted field treatment, since depending on the monitored field condition the treatment units 120, 122 may be triggered to treat the field 112. Both operations may be executed while the UAV 102, 104, 106 hovers over the respective field section 113. In other embodiments the UAV 102, 104, 106 may be a scouting UAV 102, 104, 106 including the monitoring unit 124 for monitoring field condition(s). In other embodiments the UAV 102, 104, 106 may be a spray UAV 102, 104, 106 including the treatment unit 120, 122 for spraying treatment product.

The treatment unit 120, 122 may alternatively be a seeding unit, a discharge unit, a grabber unit, a harvesting unit or the like.

The operation data may be configured to control the treatment units 120, 122. The monitoring unit 124 may comprise an optical sensor (e.g. a camera, a NIR sensor, RGB camera, LIDAR, LADAR, RGB, Laser), a GPS sensor, a temperature sensor, a humidity sensor, a sun radiation sensor, an airflow sensor, an application rate sensor, a wind speed sensor, a wind direction sensor or the like. The operation data may comprise data to control the monitoring unit 124.

FIG. 3 illustrates a ground robot 102, 104, 106 adapted for treating the agricultural field 112.

In contrast to the UAV 102, 104, 106 of FIGS. 1 and 2, the treatment device, i.e. the ground robot 102, 104, 106 of FIG. 3 is ground based and traverses on the ground. As shown in this example the robot 102, 104, 106 includes a monitoring unit 124 for monitoring field condition(s) and spray nozzles 122, 124 as treatment unit for spraying treatment product. The spray nozzles 120, 122 are in fluid connection to at least one tank carried by the robot 102, 104, 106. Similar to the flying UAV 102, 104, 106 such ground-based set up allows for more efficient and targeted field treatment, since depending on the monitored field condition the nozzles 122, 124 may be triggered to treat the agricultural field 112. In other embodiments the robot may be a scouting robot including the monitoring unit 124 for monitoring field condition(s). In other embodiments the robot may be a spray robot including the treatment unit 122, 120 for spraying treatment product.

Of course, also the ground robot 102, 104, 106 can be called an agricultural equipment.

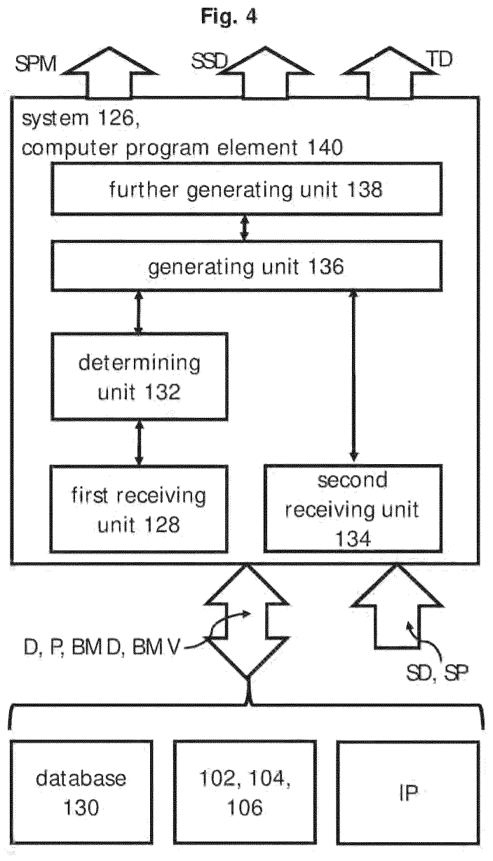

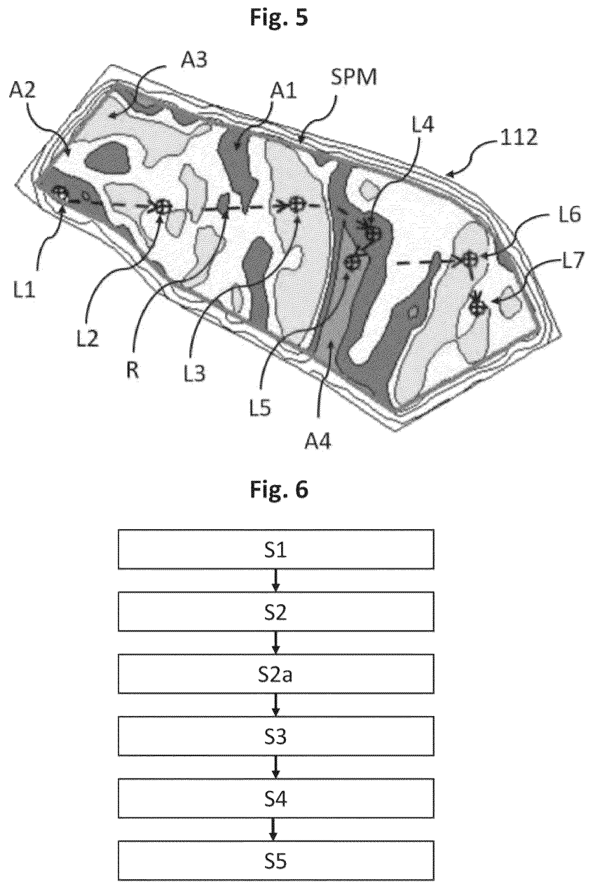

FIG. 4 illustrates a system 126 for generating a soil property map SPM of the agricultural field 112. An exemplary soil property map SPM is shown in FIG. 5.

The system 126 comprises a first receiving unit 128 configured to receive crop property distribution data D of the agricultural field 112. The crop property distribution data D comprises at least one crop related parameter P.

In the example shown in FIGS. 4 and 5, the crop property distribution data D is biomass distribution data BMD and the crop related parameter P value is a biomass value BMV.

The biomass distribution data BMD is received from a data base 130, a current measurement, e.g. performed by the agricultural equipment 102, 104, 106 as explained before or a user input IP.

The database 130 may be a part of the cloud environment 100. Alternatively, the database 130 may form part of the ground station 110 (cf. FIG. 1) in the present example:

In another example, the biomass distribution data BMD is derived from historical biomass distribution data originating from the past 10 years. The historical biomass distribution data is also provided by the database 130.

The system 126 further comprises a determining unit 132 configured to determine equivalent areas A1, A2, A3, A4 having a crop related parameter P value within a certain range in the crop property distribution data D.

In the present example, the determining unit 132 is configured to determine equivalent areas A1, A2, A3, A4 having a biomass value BMV within a certain range in the biomass distribution data BMD.

This is illustrated in FIG. 5 showing a total of four equivalent areas A1, A2, A3, A4 of the agricultural field 112.

The equivalent area A1 has a biomass value BMV within a first range. The equivalent area A2 has a biomass value BMV within a second range. The equivalent area A3 has a biomass value BMV within a third range. The equivalent area A4 has a biomass value BMV within a fourth range.

Generally speaking, it is derived from the biomass distribution data BMD that the biomass value BMV is to be considered uniform within the respective equivalent area A1, A2, A3 and A4.

It is noted that portions of one of the equivalent areas A1, A2, A3 and A4 do not necessarily need to be connected.

The system 126 additionally comprises a second receiving unit 134 which is configured to receive soil data SD.

The soil data SD comprises at least one soil parameter SP for each of the determined equivalent areas A1, A2, A3, A4. The soil parameter SP is for example a phosphorus content.

It is noted that the fact that in the present example, the soil parameter SP relates to the phosphorus content is of purely illustrative nature. The soil parameter can as well relate to any other alternative having already been explained above.

The soil parameters SP are for example determined by obtaining a soil sample at each of the sampling locations L1, L2, L3, L4, L5, L6, L7 as shown in FIG. 5.

In this example, two samples are obtained for the equivalent area A1, i.e. at locations L1 and L4.

For the equivalent area A2, also two samples are obtained, i.e. at locations L2 and L7.

For the equivalent area A3 also two samples are obtained respectively, i.e. at locations L3 and L6.

For the equivalent area A4, only one sample is obtained at location L5.

The system 126 further comprises a generating unit 136 which is configured to generate a soil property map SPM of the agricultural field 112 based on the soil data SD and the equivalent areas A1 to A4.

This means that in the example of FIG. 5, a phosphorus content (or any other above-mentioned parameter) having been derived from the samples obtained at locations L1 and L4 is attributed to the entire equivalent area A1. If at location L1 and location L4 a different phosphorus content has been found, an average phosphorus content may be used.

In the same way, a phosphorus content (or any other above-mentioned parameter) having been derived from the samples obtained at locations L2 and L7 is attributed to the entire equivalent area A2.

In the same way, a phosphorus content (or any other above-mentioned parameter) having been derived from the samples obtained at locations L3 and L6 is attributed to the entire equivalent area A3.

A phosphorus content (or any other above-mentioned parameter) having been derived from the sample obtained at locations L5 is attributed to the entire equivalent area A4.

The system 126 additionally comprises a further generating unit 138 which is configured to generate treatment instruction data TD for an agricultural equipment based on the soil property map SPM.

The agricultural equipment is for example one of agricultural equipment 102, 104, 106.

Since in the present example, the illustrative soil parameter SP is exemplarily the phosphorus content, the treatment instruction data TD may comprise instructions to provide exemplarily a phosphorus fertilizer to the equivalent areas A1 to A4 having a low phosphorus content.

The system 126 can be used to perform a computer-implemented method for generating the soil property map SPM of the agricultural field 112. The steps of this method are illustrated in FIG. 6.

In a first step S 1 the crop property distribution data D of the agricultural field 112 comprising at least one crop related parameter P is received.

As has been explained before, in the present example, the crop property distribution data D is biomass distribution data BMD and the crop related parameter value is a biomass value BMV.

The biomass distribution data BMD is received from the data base 130, a current measurement, e.g. performed by one of agricultural equipment 102, 104, 106 or a user input IP.

In an alternative example, the biomass distribution data BMD is derived from historical biomass distribution data, as has been explained above.

In a second step S2 equivalent areas A1, A2, A3, A4 having a crop related parameter P value within a certain range in the crop property distribution data D are determined.

This means that in the present example equivalent areas A1, A2, A3, A4 are determined (cf. FIG. 5). Each of these equivalent areas A1, A2, A3, A4 has a crop related parameter P value within a certain range in the crop property distribution data D.

In the present example, it is determined that the equivalent areas A1, A2, A3, A4 have a biomass value BMV within a certain range in the biomass distribution data BMD.

In more detail, the equivalent area A1 has a biomass value BMV within a first range. The equivalent area A2 has a biomass value BMV within a second range. The equivalent area A3 has a biomass value BMV within a third range. The equivalent area A4 has a biomass value BMV within a fourth range.

Generally speaking, it is derived from the biomass distribution data BMD that the biomass value BMV is to be considered uniform within the respective equivalent area A1, A2, A3 and A4.

Once the equivalent areas A1, A2, A3, A4 are determined, in an optional step S2a, soil sampling location data SSD in the agricultural field is provided. This is provided based on the determined equivalent areas, wherein also soil sampling route data for a soil sampling device is provided. Moreover, a soil sampling map data for the agricultural field.

As has been explained before, the soil sampling location data SSD comprises the location data characterizing locations L1 to L7 which are used for obtaining samples.

The soil sampling route data describes a route R connecting the locations L1 to L7 in the shortest possible manner. This is illustrated using a dashed line in FIG. 5.

Together with a contour of the agricultural field 112 the locations L1 to L7 and the route R form soil sampling map data. In simplified terms, a map of the agricultural field 112 is provided, wherein on the map sampling locations L1 to L7 are shown and a route R is suggested along which the locations L1 to L7 can be reached.

As can be seen from FIG. 5, equivalent Areas A1, A2 and A3 comprise two soil sampling locations and equivalent area A4 comprises one sampling location.

This is due to the fact that the surface of the equivalent area A4 is a lot smaller than the cumulated surface of the equivalent areas A1, A2 and A3.

Moreover, still in optional step S2a, the method may comprise a step of providing soil sampling timing data with reference to the time the soil samples have to be obtained and a step of providing soil sampling method data.

Consequently, the method is configured for fully describing a sampling procedure in terms of where, when and how. Due to this complete description, the sampling can be performed with high precision. Preferably, the sampling is done automatically.

In a third step S3 the soil data SD with respect to at least one soil parameter SP, in the present example a phosphorus content, is received for each of the determined equivalent areas A1 to A4.

The soil data SD is for example generated by a sampling procedure as described above and in conjunction with the system 126.

As a consequence of step S3, in the present example, the phosphorus content of all equivalent areas A1 to A4 is known.

The soil property map SPM of the agricultural field 112 is generated in a fourth step S4. To this end, the soil data SD, i.e. in the present example the phosphorus contents, and the equivalent areas A1 to A4 are used.

More precisely, the determined phosphorus content is attributed to the relevant equivalent area A1 to A4 and represented in a map.

In other words, the crop property distribution data D of the agricultural field 112 or biomass distribution data BMD and/or soil data SD are used in a method for generating a soil property map SPM of the agricultural field 112.

In a fifth step S5, the method further comprises a step of generating treatment instruction data TD for an agricultural equipment, e.g. agricultural equipment 102, 104, 106. The soil property map SPM is used as a basis for this step.

As has already been explained, in an illustrative example, the treatment may be the application of a phosphorus fertilizer and the treatment instruction data TD may comprise instructions to provide the phosphorus fertilizer to the equivalent areas A1 to A4 having a low phosphorus content. The treatment instruction data TD may comprise corresponding location data and corresponding data relating to the quantity of phosphorus fertilizer to be applied.

Thus, the soil property map SPM provided by the method for generating a soil property map SPM is used for providing treatment instruction data TD for an agricultural equipment, e.g. agricultural equipment 102, 104, 106, for treating the agricultural field 112.

Moreover, method for generating a soil property map SPM may be realized by a computer program element 140 with instructions, which, when executed on computing devices of a computing environment, is configured to carry out the steps of the method as described above in a system 126 as described above. To this end, the computer program element 140 may comprise computer program units, for example software units, corresponding to the units of the system 126. This is illustrated in FIG. 4.

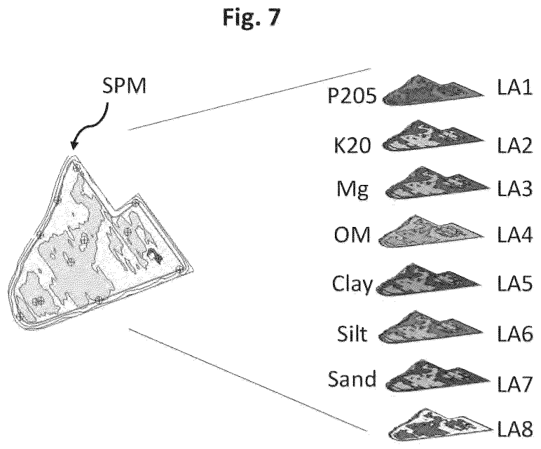

In FIG. 7 another example of a soil property map SPM having been generated by the method for generating a soil property map and the system 126 is illustrated.

The soil property map SPM of FIG. 7 differs in several aspects from the SPM of FIG. 5. For the remaining aspects, references is made to the above explanations.

First of all, it relates to a different agricultural field having a different geometry.

Moreover, the soil property map SPM of FIG. 7 comprises a plurality of layers LA1 to LA8. In the example of FIG. 7 a total number of eight layers is used, however this is purely illustrative.

Each of the layers LA1 to LA8 relates to a different soil parameter SP. Any type of soil parameter can be chosen from the above list.

This means that for generating the soil property map SPM of FIG. 7, the equivalent areas are determined as has been described before, however then soil data SD relating to a total of eight soil parameters SP is received and for each soil parameters SP a layer of the soil property map SPM is generated.

It is noted that the method for generating a soil property map SPM can be performed on any one of the cloud environment 100, the ground station(s) 110 and the user device(s) 108. To this end, a corresponding computer program element 140 is provided on any one of the cloud environment 100, the ground station(s) 110 and the user device(s) 108. This means, that also the system 126 for generating a soil property map SPM can form at least part of any one of the cloud environment 100, the ground station(s) 110 and the user device(s) 108.

Aspects of the present disclosure relates to computer program elements configured to carry out steps of the methods described above. The computer program element might therefore be stored on a computing unit of a computing device, which might also be part of an embodiment. This computing unit may be configured to perform or induce performing of the steps of the method described above. Moreover, it may be configured to operate the components of the above described system. The computing unit can be configured to operate automatically and/or to execute the orders of a user. The computing unit may include a data processor. A computer program may be loaded into a working memory of a data processor. The data processor may thus be equipped to carry out the method according to one of the preceding embodiments. This exemplary embodiment of the present disclosure covers both, a computer program that right from the beginning uses the present disclosure and computer program that by means of an update turns an existing program into a program that uses the present disclosure. Moreover, the computer program element might be able to provide all necessary steps to fulfill the procedure of an exemplary embodiment of the method as described above. According to a further exemplary embodiment of the present disclosure, a computer readable medium, such as a CD-ROM, USB stick, a downloadable executable or the like, is presented wherein the computer readable medium has a computer program element stored on it which computer program element is described by the preceding section. A computer program may be stored and/or distributed on a suitable medium, such as an optical storage medium or a solid state medium supplied together with or as part of other hardware, but may also be distributed in other forms, such as via the internet or other wired or wireless telecommunication systems. However, the computer program may also be presented over a network like the World Wide Web and can be downloaded into the working memory of a data processor from such a network. According to a further exemplary embodiment of the present disclosure, a medium for making a computer program element available for downloading is provided, which computer program element is arranged to perform a method according to one of the previously described embodiments of the present disclosure.

The present disclosure has been described in conjunction with a preferred embodiment as examples as well. However, other variations can be understood and effected by those persons skilled in the art and practicing the claimed invention, from the studies of the drawings, this disclosure and the claims. Notably, in particular, the any steps presented can be performed in any order, i.e. the present invention is not limited to a specific order of these steps. Moreover, it is also not required that the different steps are performed at a certain place or at one node of a distributed system, i.e. each of the steps may be performed at a different nodes using different equipment/data processing units.

In the claims as well as in the description the word “comprising” does not exclude other elements or steps and the indefinite article “a” or “an” does not exclude a plurality. A single element or other unit may fulfill the functions of several entities or items recited in the claims. The mere fact that certain measures are recited in the mutual different dependent claims does not indicate that a combination of these measures cannot be used in an advantageous implementation.

What is claimed is:

1. A method comprising:
receiving, by a processing device, crop property distribution data of an agricultural field comprising at least one crop related parameter;
determining equivalent areas having a crop related parameter value within a range in the crop property distribution data;
receiving soil data with respect to at least one soil parameter for each of the equivalent areas; and
generating a soil property map of the agricultural field based on the soil data and the equivalent areas.

2. The method of claim 1, further comprising generating treatment instruction data for an agricultural equipment based at least in part on the soil property map.

3. The method of claim 1, wherein the crop property distribution data comprises biomass distribution data and the crop related parameter value comprises a biomass value.

4. The method of claim 3, wherein the biomass distribution data is received from at least one of a data base, a current measurement, or a user input.

5. The method of claim 3, wherein the biomass distribution data is derived from historical biomass distribution data, wherein the historical biomass distribution data is from one of not less than 2 years, not less than 4 years, not less than 8 years, or not less than 10 years.

6. The method of claim 1, further comprising of providing soil sampling location data in the agricultural field based at least in part on the equivalent areas, wherein at least one of soil sampling route data for a soil sampling device to navigate through the agricultural field is provided or soil sampling map data for the agricultural field is provided.

7. The method of claim 6, wherein the soil sampling location data comprises one of between one and ten soil sampling locations for each equivalent area, between two and seven soil sampling locations for each equivalent area, between four and six soil sampling locations for each equivalent area, or one soil sampling location for each equivalent area.

8. The method of claim 1, further comprising providing soil sampling timing data with reference to a time one or more soil samples of the soil data are to be obtained.

9. The method of claim 1, further comprising providing soil sampling method data.

10. The method of claim 1, wherein the soil data relates to one or more of: soil organic matter, total carbon content, organic carbon content, inorganic carbon content, soil humus content, boron content, phosphorus content, potassium content, nitrogen content, sulfur content, calcium content, iron content, aluminum content, chlorine content, molybdenum content, magnesium content, nickel content, copper content, zinc content, Manganese content, pH value of soil in the agricultural field or a sub-field zone, soil quality, soil sandiness, soil moisture, soil humidity, soil temperature, soil surface temperature, soil density, soil texture, soil conductivity, water holding capacity, clay content, silt content, or sand content of the soil.

11. A system comprising:
a first receiving unit configured to receive crop property distribution data of an agricultural field comprising at least one crop related parameter;
a determining unit configured to determine equivalent areas having a crop related parameter value within a range in the crop property distribution data;
a second receiving unit configured to receive soil data with respect to at least one soil parameter for each of the equivalent areas; and
a generating unit configured to generate a soil property map of the agricultural field based on the soil data and the equivalent areas.

12. The system of claim 11, further comprising an additional generating unit configured to generate treatment instruction data for an agricultural equipment based at least in part on the soil property map.

13. A non-transitory computer-readable medium comprising instructions, which when executed by a processing device, cause the processing device to perform operations comprising:
receiving crop property distribution data of an agricultural field comprising at least one crop related parameter;
determining equivalent areas having a crop related parameter value within a range in the crop property distribution data;
receiving soil data with respect to at least one soil parameter for each of the equivalent areas;
generating a soil property map of the agricultural field based on the soil data and the equivalent areas.

14. The non-transitory computer-readable medium of claim 13, the operations further comprising using at least one of crop property distribution data of the agricultural field or of biomass distribution data or soil data.

15. The non-transitory computer-readable medium of claim 13, the operations further comprising using a soil property map to provide treatment instruction data for agricultural equipment for treating the agricultural field.
